(19) United States
(12) Patent Application Publication
(10) Pub. No.: US 2026/0100072 A1
(43) Pub. Date: Apr. 9, 2026

(54) SYSTEM AND METHOD TO PROVIDE FLEXIBLE SYNTHETIC VEHICLE SIGNALS

(71) Applicant: FCA US LLC, Auburn Hills, MI (US)

(72) Inventors: Raghuvirsinh Sodha, Auburn Hills, MI (US); Andrew Hoin, Auburn Hills, MI (US); Charlie Cross, Auburn Hills, MI (US); William Keegan, Auburn Hills, MI (US)

(21) Appl. No.: 18/910,423

(22) Filed: Oct. 9, 2024

(51) Int. Cl. G07C 5/00; G07C 5/08

(52) U.S. Cl. CPC G07C 5/006; G07C 5/008; G07C 5/0816

(57) ABSTRACT

Synthetic signal creation and management systems and methods for a vehicle include a cloud-based network configured to generate a software policy for a synthetic signal engine and an electronic control unit (ECU) of the vehicle that is configured to receive the software policy from the cloud-based network, configure the synthetic signal engine based on the software policy, execute the synthetic signal engine to create, based on datapoints for two or more foundational vehicle signals, a synthetic vehicle signal, and output the synthetic vehicle signal. The synthetic vehicle signal could comprises concurrent datapoints for the two or more foundational vehicle signals or datapoints for the two or more foundational vehicle signals, respectively, over a specified duration of time. The synthetic signal engine could also be configured to create the synthetic vehicle signal based further on at least one other previously-created synthetic vehicle signal.

### FIELD

The present application generally relates to vehicle data collection and, more particularly, to a system and method for providing flexible synthetic vehicle signals.

### BACKGROUND

Today's vehicles include a plurality of electronic control units (ECUs) configured to transmit signals via communication buses, such as a controller area network (CAN). Traditional static data collection methods are inefficient and costly, particularly when faced with dynamic demands such as those encountered in contemporary designs. This has led to the adoption of dynamic, policy-based cloud-configured data collection. The term “policy” refers to a configuration for deployment of a software code or application. For example, the policy specifies the various signals that could be reported to a cloud-based network, where the signals could be analyzed or processed to determine some desired value. While this approach addresses the issue of flexibility, it lacks on-board capabilities for transforming or summarizing collected data. Accordingly, while such conventional solutions do work for their intended purpose, there exists an opportunity for improvement in the relevant art.

### SUMMARY

According to one example aspect of the invention, a synthetic signal creation and management system for a vehicle is presented. In one exemplary implementation, the system comprises a cloud-based network configured to generate a software policy for a synthetic signal engine and an electronic control unit (ECU) of the vehicle that is configured to receive the software policy from the cloud-based network, configure the synthetic signal engine based on the software policy, execute the synthetic signal engine to create, based on datapoints for two or more foundational vehicle signals, a synthetic vehicle signal, and output the synthetic vehicle signal.

In some implementations, the synthetic vehicle signal comprises concurrent datapoints for the two or more foundational vehicle signals. In some implementations, synthetic vehicle signal comprises datapoints for the two or more foundational vehicle signals, respectively, over a specified duration of time.

In some implementations, the synthetic signal engine is configured to create the synthetic vehicle signal based further on at least one other previously-created synthetic vehicle signal.

In some implementations, the synthetic vehicle signal is output to another ECU of the vehicle. In some implementations, the synthetic vehicle signal is output to the cloud-based network.

In some implementations, the synthetic vehicle signal did not previously exist and is not a foundational vehicle signal. In some implementations, the foundational vehicle signals are defined by an automotive standard or specification.

In some implementations, the synthetic vehicle signal is a vehicle low tire pressure indication signal, and wherein the datapoints are for four foundational tire pressure signals relative to respective low tire pressure thresholds.

According to another example aspect of the invention, a synthetic signal creation and management method for a vehicle is presented. In one exemplary implementation, the method comprises generating, by a cloud-based network, a software policy for a synthetic signal engine, receiving, by an ECU of the vehicle and from the cloud-based network, the software policy, configuring, by the ECU, the synthetic signal engine based on the software policy, executing, by the ECU, the synthetic signal engine to create, based on datapoints for two or more foundational vehicle signals, a synthetic vehicle signal, and outputting, by the ECU, the synthetic vehicle signal.

In some implementations, the synthetic vehicle signal comprises concurrent datapoints for the two or more foundational vehicle signals. In some implementations, the synthetic vehicle signal comprises datapoints for the two or more foundational vehicle signals, respectively, over a specified duration of time.

In some implementations, the synthetic signal engine is configured to create the synthetic vehicle signal based further on at least one other previously-created synthetic vehicle signal.

In some implementations, the synthetic vehicle signal is output to another ECU of the vehicle. In some implementations, the synthetic vehicle signal is output to the cloud-based network.

In some implementations, the synthetic vehicle signal did not previously exist and is not a foundational vehicle signal. In some implementations, the foundational vehicle signals are defined by an automotive standard or specification.

In some implementations, the synthetic vehicle signal is a vehicle low tire pressure indication signal, and wherein the datapoints are for four foundational tire pressure signals relative to respective low tire pressure thresholds.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams depicting an example vehicle and an example synthetic signal creation and management system according to the principles of the present application;

FIG. 2 is a functional block diagram depicting an example operation of the synthetic signal creation and management system according to the principles of the present application; and

FIG. 3 is a flow diagram depicting an example synthetic signal creation and management method for a vehicle according to the principles of the present application.

### DESCRIPTION

As previously discussed, today's vehicles include a plurality of electronic control units (ECUs) configured to transmit signals via communication buses, such as a controller area network (CAN). Traditional static data collection methods are inefficient and costly, particularly when faced with dynamic demands such as those encountered in contemporary designs. This has led to the adoption of dynamic, policy-based cloud-configured data collection. The term “policy” refers to a configuration for deployment of a software code or application. For example, the policy specifies the various signals that could be reported to a cloud-based network, where the signals could be analyzed or processed to determine some desired value. While this approach addresses the issue of flexibility, it lacks on-board capabilities for transforming or summarizing collected data. In the example of vehicle tire pressure monitoring, individual tire pressure signals could be reported to the cloud, where they could be analyzed and processed (e.g., relative to respective pressure thresholds) to determine whether any of the vehicle's tires have insufficient pressure and a vehicle low tire pressure flag should be set.

Accordingly, a system and method for synthetic signal creation and management for a vehicle are presented herein. These techniques leverage a no-code, policy-based synthetic transformation framework (a synthetic signal engine) that eliminates the need for manual coding while providing flexibility in signal generation from foundational vehicle signal data points. The synthetic signal engine, operating at the ECU level of the vehicle, is configured to generate synthetic signals based on previously defined or existing signals. Synthetic signals could also be defined based on one or more other synthetic signals. In the above-mentioned example of tire pressure monitoring, instead of a cloud-based analysis of individual tire pressure signals to determine a vehicle low tire pressure flag, a synthetic signal for low tire pressure could be created based on all four tires pressure signals and their respective threshold comparisons.

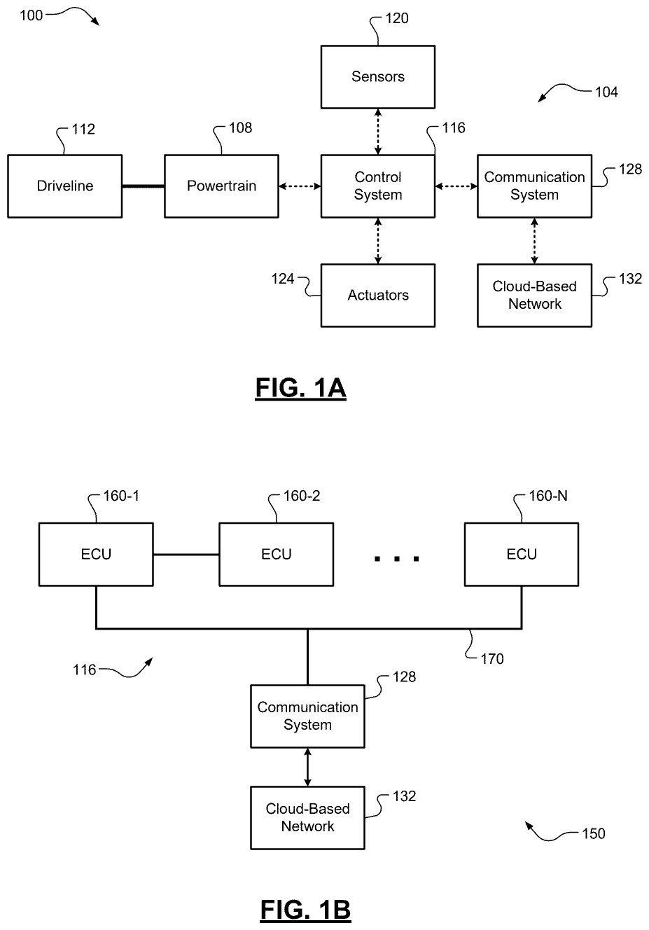

Referring now to FIGS. 1A-1B, functional block diagrams depicting an example vehicle 100 having a synthetic signal creation and management system 104 and an example configuration 150 of the synthetic signal creation and management system 104 are illustrated. The vehicle 100 could have any suitable configuration but, for illustrative/descriptive purposes, the vehicle 100 is shown to generally include a powertrain 108 configured to generate and transfer torque to a driveline 112 for propulsion. Non-limiting examples of the components of the powertrain 108 include an engine, an electric motor, a transmission, and combinations thereof. Non-limiting examples of the components of the driveline 112 include axles or half-shafts, differentials, and wheels.

A control system 116 is configured to control operation of the vehicle 100. Specifically, the control system 116 is configured to receive measurements from a plurality of sensors 120 and to control a plurality of actuators or other vehicle systems 124. For example only, the control system 116 could receive a driver torque request via a driver interface or sensor (e.g., an accelerator pedal) and then control the powertrain 108 to generate an amount of drive torque to satisfy the driver torque request.

The control system 116 is also configured to communicate with external computing systems via a communication system 128 (e.g., a transceiver) and a network (e.g., a cellular or satellite data network). One such remote system is a cloud-based system or network 132, which could be one or more OEM computing servers and, in some cases, one or more authenticated software/application developer computing devices. In one exemplary configuration 150, the control system 116 comprises a plurality of controllers or ECUs 160-1 . . . 160-N (N being an integer greater than one; collectively, “ECUs 160”) configured to communicate with each other via a CAN 170 comprising one or more CAN buses. For example, the CAN 170 could include a plurality of different CAN buses and each CAN bus could be configured to broadcast a certain set of ECU signals. Non-limiting examples of the ECUs 160 include a supervisory or primary ECU (e.g., a vehicle control unit, or VCU) and subsidiary or secondary ECUs (an engine control unit, or ECU, a motor control unit, or MCU, a transmission control unit, or TCU, etc.). Based on their respective software policies, the ECUs 160 collect data (e.g., ECU signals), which could then be reported back to the cloud-based network 132.

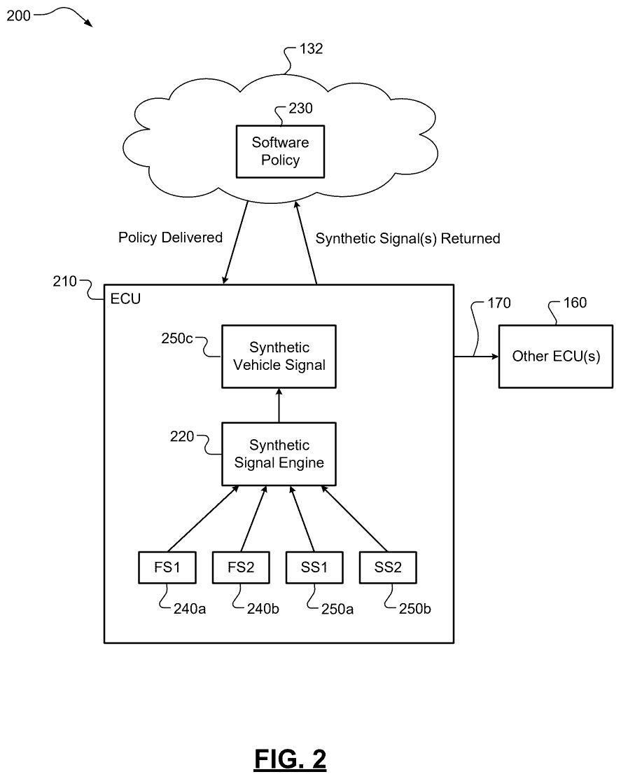

Referring now to FIG. 2 and with continued reference to FIGS. 1A-1B, functional block diagrams depicting an example operation 200 of the synthetic signal creation and management system 104 according to the principles of the present application are illustrated. The vehicle 100 and its related components (e.g., the cloud-based network 132) are specifically referenced for descriptive/illustrative purposes. As shown, an ECU 210 (e.g., one of the ECUs 160 of vehicle 100) is configured to communicate with the cloud-based network 132, such as via one or more communication networks (a cellular data network, a satellite data network, etc.). As mentioned, the cloud-based network 132 could be associated with an OEM of the vehicle 100 and could include, for example only, an OEM computing device/server or an authenticated computing device.

The ECU 210 is configured to execute a synthetic signal engine 220 according to a software policy 230. The software policy 230 could be provided, for example, to the ECU 210 from an automotive software engineer (e.g., via the cloud-based network 132 as shown). The software policy defines configuration parameters for the synthetic signal engine 220. More specifically, the software policy defines what synthetic vehicle signals the synthetic signal engine 220 is to create and how to create each of those synthetic vehicle signals. Thus, engineers are able to easily configure the synthetic signal engine 220 over time, such as for various development and testing tasks. In one example, each synthetic vehicle signal is based on two or more foundational vehicle signals. The term “foundational vehicle signal” as used herein refers to an existing or predefined vehicle signal, such as according to an automotive standard or specification (e.g., AUTomotive Open System ARchitecture, or AUTOSAR®).

The synthetic vehicle signals, in contrast, are new and previously did not exist prior to creation by the synthetic signal engine 220 or another synthetic signal engine from another ECU.

Some examples of foundational vehicle signals include, but are not limited to, speeds, temperatures, pressures (e.g., tire pressure) of various components of the powertrain 108 or parameters measured by the sensors 120. The synthetic vehicle signals could be based on any combination of two or more foundational vehicle signals, one or more foundational vehicle signals and a respective threshold comparison, one or more previously-created other synthetic vehicle signals, or combinations thereof.

As shown in FIG. 2, for example, the synthetic signal engine 220 receives two foundational vehicle signals FS1 240a, FS2 240b and two previously-created other synthetic vehicle signals SS1 250a, SS2 250b and creates a new synthetic vehicle signal 250c. After creation/generation, the synthetic signal(s) from the synthetic signal engine 220 are output from the ECU 210, such as to another ECU 260 (e.g., via the CAN 170) and/or back to the cloud-based network 132, depending on the desired usage for the synthetic vehicle signal(s).

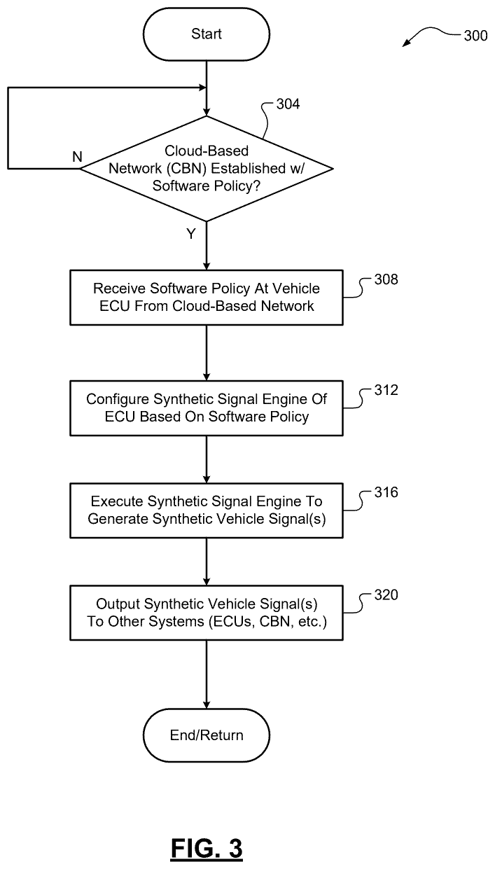

Referring now to FIG. 3 and with continued reference to the previous figures, a flow diagram depicting an example synthetic signal creation and management method 300 for a vehicle according to the principles of the present application is illustrated. While the method 300 specifically references the previous figures (FIGS. 1A-1B and 2) and the previously discussed components (e.g., vehicle 100), it will be appreciated that the method 300 could be applicable to any suitable vehicle and CAN network implementations. The method 300 begins at 304 where the cloud-based network 132 is established and the software policy 230 is generated. At 308, the software policy 230 is transmitted from the cloud-based network 132 and received by the ECU 210. At 312, the ECU 210 utilizes the software policy to configure the synthetic signal engine 220. The software policy 230 defines configuration parameters for the synthetic signal engine 220. As previously discussed, the software policy 230 could be generated or updated based on input from an automotive engineer such that the synthetic signal engine 220 will operate to generate a desired set of synthetic vehicle signals.

At 316, the ECU 210 executes the synthetic signal engine 220 to create, based on datapoints for two or more foundational vehicle signals, a synthetic vehicle signal. This operation 316 could be repeated to generate multiple desired synthetic vehicle signals according to the software policy 230, which could include synthetic vehicle signals based on other previously-created synthetic vehicle signals as previously discussed herein. At 320, the ECU 210 outputs the synthetic vehicle signal(s), such as to other ECU(s) 160 via the CAN and/or back to the cloud-based network 132. The method 300 then ends or returns to 304 or 308 (e.g., where another revised/updated software policy 230 could be subsequently generated at the cloud-based network 132 and then provided to the ECU 210).

In summary, in modern vehicles, many ECUs, sensors, and actuators assume a pivotal role. These advanced components provide vital real-time insights into the status of diverse vehicle parts and can assess environmental variables such as road conditions, weather patterns, air quality, and traffic dynamics. Moreover, these vehicles are outfitted with connectivity devices designed to establish connections with cloud infrastructure. Through these connections, pertinent information is transmitted to the cloud environment. This data is harnessed within the cloud to furnish an array of customer-centric features. Furthermore, engineers utilize this dataset to scrutinize vehicle performance, enhance component quality and durability, and effectively address on-road issues. In addition, this anonymized data is employed by marketing teams to effectively target their campaigns towards specific audiences. This invaluable dataset is also leveraged by product designers to enact beneficial and economically efficient enhancements to the vehicle's design. This integrated approach described in detail herein enhances customer experiences and contributes to the advancement of vehicle technology and performance.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A synthetic signal creation and management system for a vehicle, the system comprising:
a cloud-based network configured to generate a software policy for a synthetic signal engine; and
an electronic control unit (ECU) of the vehicle that is configured to:
receive the software policy from the cloud-based network;
configure the synthetic signal engine based on the software policy;
execute the synthetic signal engine to create, based on datapoints for two or more foundational vehicle signals, a synthetic vehicle signal; and
output the synthetic vehicle signal.

2. The system of claim 1, wherein the synthetic vehicle signal comprises concurrent datapoints for the two or more foundational vehicle signals.

3. The system of claim 1, wherein the synthetic vehicle signal comprises datapoints for the two or more foundational vehicle signals, respectively, over a specified duration of time.

4. The system of claim 1, wherein the synthetic signal engine is configured to create the synthetic vehicle signal based further on at least one other previously-created synthetic vehicle signal.

5. The system of claim 1, wherein the synthetic vehicle signal is output to another ECU of the vehicle.

6. The system of claim 1, wherein the synthetic vehicle signal is output to the cloud-based network.

7. The system of claim 1, wherein the synthetic vehicle signal did not previously exist and is not a foundational vehicle signal.

8. The system of claim 1, wherein the foundational vehicle signals are defined by an automotive standard or specification.

9. The system of claim 1, wherein the synthetic vehicle signal is a vehicle low tire pressure indication signal, and wherein the datapoints are for four foundational tire pressure signals relative to respective low tire pressure thresholds.

10. A synthetic signal creation and management method for a vehicle, the method comprising:
generating, by a cloud-based network, a software policy for a synthetic signal engine;
receiving, by an electronic control unit (ECU) of the vehicle and from the cloud-based network, the software policy;
configuring, by the ECU, the synthetic signal engine based on the software policy;
executing, by the ECU, the synthetic signal engine to create, based on datapoints for two or more foundational vehicle signals, a synthetic vehicle signal; and
outputting, by the ECU, the synthetic vehicle signal.

11. The method of claim 10, wherein the synthetic vehicle signal comprises concurrent datapoints for the two or more foundational vehicle signals.

12. The method of claim 10, wherein the synthetic vehicle signal comprises datapoints for the two or more foundational vehicle signals, respectively, over a specified duration of time.

13. The method of claim 10, wherein the synthetic signal engine is configured to create the synthetic vehicle signal based further on at least one other previously-created synthetic vehicle signal.

14. The method of claim 10, wherein the synthetic vehicle signal is output to another ECU of the vehicle.

15. The method of claim 10, wherein the synthetic vehicle signal is output to the cloud-based network.

16. The method of claim 10, wherein the synthetic vehicle signal did not previously exist and is not a foundational vehicle signal.

17. The method of claim 10, wherein the foundational vehicle signals are defined by an automotive standard or specification.

18. The method of claim 10, wherein the synthetic vehicle signal is a vehicle low tire pressure indication signal, and wherein the datapoints are for four foundational tire pressure signals relative to respective low tire pressure thresholds.
